(19) United States
(12) Patent Application Publication
(10) Pub. No.: US 2026/0228525 A1
(43) Pub. Date: Aug. 6, 2026

(54) DYNAMIC CLASS-INCREMENTAL LEARNING WITHOUT FORGETTING

(71) Applicant: QUALCOMM Incorporated, San Diego, CA (US)

(72) Inventors: Haijun ZHAO, Beijing (CN); Yinxiong YAO, Beijing (CN)

(21) Appl. No.: 19/153,308

(22) PCT Filed: Mar. 24, 2023
(86) PCT No.: PCT/CN2023/083626

§ 371 Date: Aug. 1, 2025

(51) Int. Cl. G06N 3/08; G06N 3/045; G06N 3/0464

(52) U.S. Cl. CPC G06N 3/08; G06N 3/045; G06N 3/0464

(57) ABSTRACT

A processor-implemented method for dynamic class-incremental learning without forgetting includes receiving, by an artificial neural network (ANN), an input. The ANN extracts features of the input to generate a representation of the input. An embedding is generated by the ANN based on the representation and multiple similarity metrics. The ANN generates a new class without retraining the ANN. The new class is generated based on a comparison of the embedding and a set of prior embeddings.

### FIELD OF THE DISCLOSURE

Aspects of the present disclosure generally relate to artificial neural networks, and more particularly, to dynamic class-incremental learning without forgetting.

### BACKGROUND

Artificial neural networks may comprise interconnected groups of artificial neurons (e.g., neuron models). The artificial neural network may be a computational device or represented as a method to be performed by a computational device.

Neural networks consist of operands that consume tensors and produce tensors. Neural networks can be used to solve complex problems, however, because the network size and the number of computations that may be performed to produce the solution may be voluminous, the time for the network to complete a task may be long. Furthermore, because these tasks may be performed on mobile devices, which may have limited computational power, the computational costs of deep neural networks may be problematic.

Convolutional neural networks are a type of feed-forward artificial neural network. Convolutional neural networks may include collections of neurons that each have a receptive field and that collectively tile an input space. Convolutional neural networks (CNNs) such as deep convolutional neural networks (DCNs) have numerous applications. In particular, these neural network architectures are used in various technologies, such as image recognition, pattern recognition, speech recognition, autonomous driving, and other classification tasks.

With the rapid development of deep learning, current deep models may learn a fixed number of classes with high performance. However, data often comes from an open environment, and may be in a streamed format or may only be temporarily available, for example due to privacy issues. As a result, learning new classes of data without restarting the training process is challenging.

### SUMMARY

The present disclosure is set forth in the independent claims, respectively. Some aspects of the disclosure are described in the dependent claims.

In one aspect of the present disclosure, a processor-implemented method includes receiving, by a first artificial neural network (ANN), an input. The method further includes extracting, by the first ANN, features of the input to generate a representation of the input. The method still further includes generating, by the first ANN, an embedding based on the representation and multiple similarity metrics. The method also includes generating, by the first ANN, a new class without retraining the first ANN, the new class being generated based on a comparison of the embedding and a set of prior embeddings.

Another aspect of the present disclosure is directed to an apparatus having a memory and one or more processors coupled to the memory. The processor(s) is configured to receive, by a first artificial neural network (ANN), an input. The processor(s) is further configured to extract, by the first ANN, features of the input to generate a representation of the input. The processor(s) is still further configured to generate, by the first ANN, an embedding based on the representation and multiple similarity metrics. The processor(s) is also configured to generate, by the first ANN, a new class without retraining the first ANN, the new class being generated based on a comparison of the embedding and a set of prior embeddings.

In another aspect of the present disclosure, a processor-implemented method includes receiving, by an artificial neural network (ANN) at a user device, an input. The method further includes extracting, by the ANN, features of the input to generate a representation of the input. The method still further includes generating, by the ANN, an input embedding based on the representation and a learned multiple similarity. The method also includes comparing the input embedding to a set of embeddings stored at the user device. The method further includes generating an inference for the input based on the comparison of the input embedding and the set of embeddings.

Another aspect of the present disclosure is directed to an apparatus having a memory and one or more processors coupled to the memory. The processor(s) is configured to receive, by an artificial neural network (ANN) at a user device, an input. The processor(s) is further configured to extract, by the ANN, features of the input to generate a representation of the input. The processor(s) is still further configured to generate, by the ANN, an input embedding based on the representation and a learned multiple similarity. The processor(s) is also configured to compare the input embedding to a set of embeddings stored at the user device. The processor(s) is further configured to generate an inference for the input based on the comparison of the input embedding and the set of embeddings.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SoC), including a general-purpose processor, in accordance with certain aspects of the present disclosure.

FIGS. 2A, 2B, and 2C are diagrams illustrating a neural network, in accordance with aspects of the present disclosure.

FIG. 2D is a diagram illustrating an exemplary deep convolutional network (DCN), in accordance with aspects of the present disclosure.

FIG. 3 is a block diagram illustrating an exemplary deep convolutional network (DCN), in accordance with aspects of the present disclosure.

FIG. 4 is a block diagram illustrating an exemplary software architecture that may modularize artificial intelligence (AI) functions.

FIG. 5 is a block diagram illustrating an example architecture for dynamic class incremental learning without forgetting, in accordance with aspects of the present disclosure.

FIG. 6A is a diagram illustrating an example multi-similarity loss, in accordance with aspects of the present disclosure.

FIG. 6B shows example graphs illustrating weighting of positive pairs and negative pairs shown in FIG. 6A based on multiple similarities, in accordance with aspects of the present disclosure.

FIG. 7 is a visual flow diagram illustrating an example process for computing a multi-similarity loss, in accordance with aspects of the present disclosure.

FIGS. 8 and 9 are flow diagrams illustrating processor-implemented methods for dynamic class-incremental learning without forgetting, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Incremental learning aims to develop artificially intelligent systems that can continuously learn to address new tasks from new data while preserving knowledge learned from previously learned tasks. Incremental learning may enable efficient resource usage by eliminating the retraining from scratch at the arrival of new data. In addition, incremental learning may reduce memory usage by limiting the amount of data to be stored, which may be important when privacy limitations are imposed. Furthermore, incremental learning may enable artificial neural networks to learn in a manner that more closely resembles human learning.

When an artificial neural network is presented with new data that is different than the data included in an initial training data set for the artificial neural network, attempts to classify the new data may result in erroneous classifications. One conventional approach to address this issue involves retraining the deep neural network to modify a class head (e.g., last fully connected (FC) layer) and retrain/finetune state of the art (SOTA) model deep neural networks (DNNs) (e.g., convolutional neural networks, such as a convolutional neural network (CNN)/transformer) with the incoming new data (e.g., unseen classes). This approach may be applied, for example, when training a robot in the open world, as the robot observes new objects or in an electronic commerce platform, as new types of products appear. Additionally, examples may include accident data in an autonomous driving scenario and expensive data annotation (e.g., disease data for medical diagnosis). However, retraining/fine tuning may suffer from a catastrophic forgetting phenomenon. Catastrophic forgetting refers to a neural network model that loses its generalization ability on a task after being trained on a new task. The new task may override the weights learned by the neural network and thus may degrade performance (e.g., classifier accuracy) for the past tasks. That is, due to the absence of previous data, especially on-device, performance for inferences on former classes may drastically drop.

Accordingly, to address these and other challenges, aspects of the present disclosure are directed to dynamic class incremental learning without forgetting.

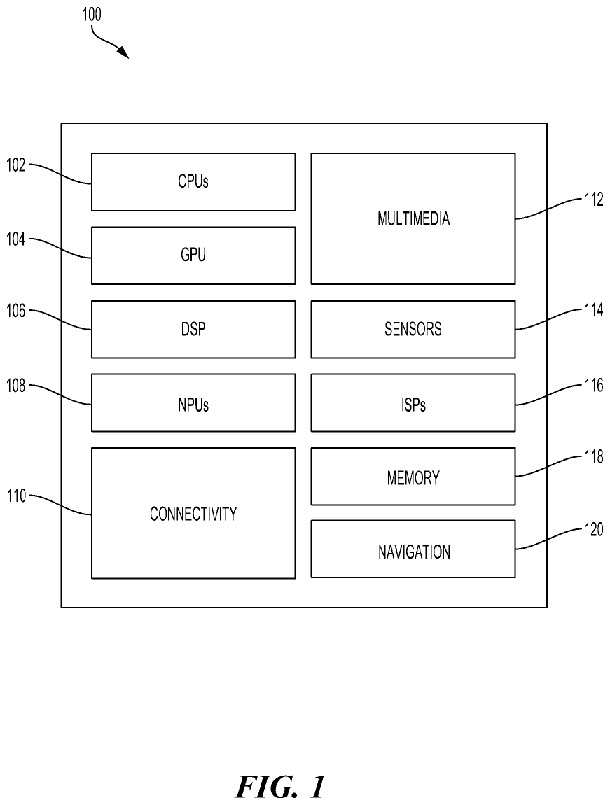

FIG. 1 illustrates an example implementation of a system-on-a-chip (SoC) 100, which may include a central processing unit (CPU) 102 or a multi-core CPU configured for dynamic class-incremental learning without forgetting (e.g., a neural end-to-end network). Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SoC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SoC 100 may also include a sensor processor 114, image signal processors (ISPs) 116, and/or navigation module 120, which may include a global positioning system.

The SoC 100 may be based on an ARM instruction set. In an aspect of the present disclosure, the instructions loaded into the general-purpose processor 102 may include code to receive, by a first artificial neural network (ANN), an input. The general-purpose processor 102 may also include code to extract, by the first ANN, features of the input to generate a representation of the input. The general-purpose processor 102 may additionally include code to generate, by the first ANN, an embedding based on the representation and multiple similarity metrics. The general-purpose processor 102 may further include code to generate, by the first ANN, a new class without retraining the first ANN. The new class is generated based on a comparison of the embedding and a set of prior embeddings.

In another aspect of the present disclosure, the instructions loaded into the general-purpose processor 102 may include code to receive, by an artificial neural network (ANN) at a user device, an input. The general-purpose processor 102 may also include code to extract, by the ANN, features of the input to generate a representation of the input. The general-purpose processor 102 may additionally include code to generating, by the ANN, an input embedding based on the representation and a learned multiple similarity. The general-purpose processor 102 may further include code to compare the input embedding to a set of embeddings stored at the user device. The general-purpose processor 102 may also include code to generate an inference for the input based on the comparison of the input embedding and the set of embeddings.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, then the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

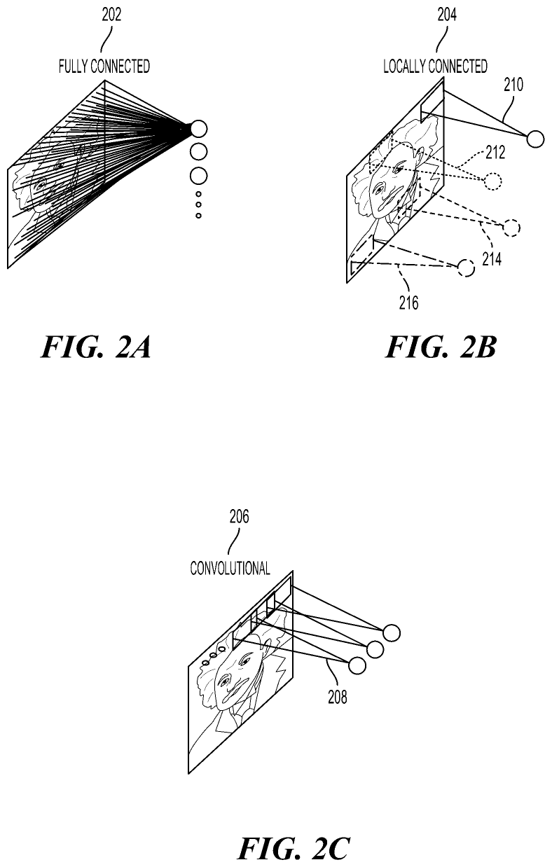

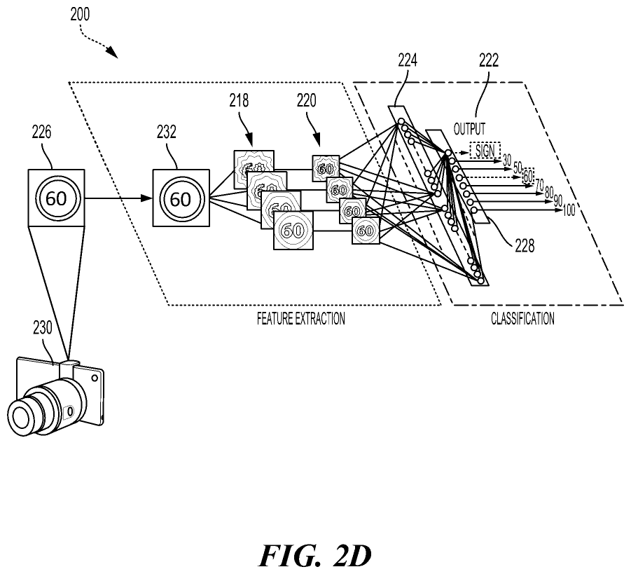

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

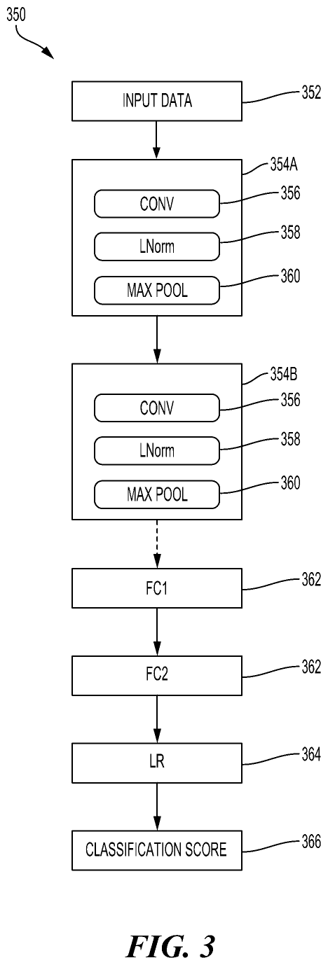

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SoC 100 to achieve high performance and low power consumption. In alternative embodiments, the parallel filter banks may be loaded on the DSP 106 or an ISP 116 of an SoC 100. In addition, the deep convolutional network 350 may access other processing blocks that may be present on the SoC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

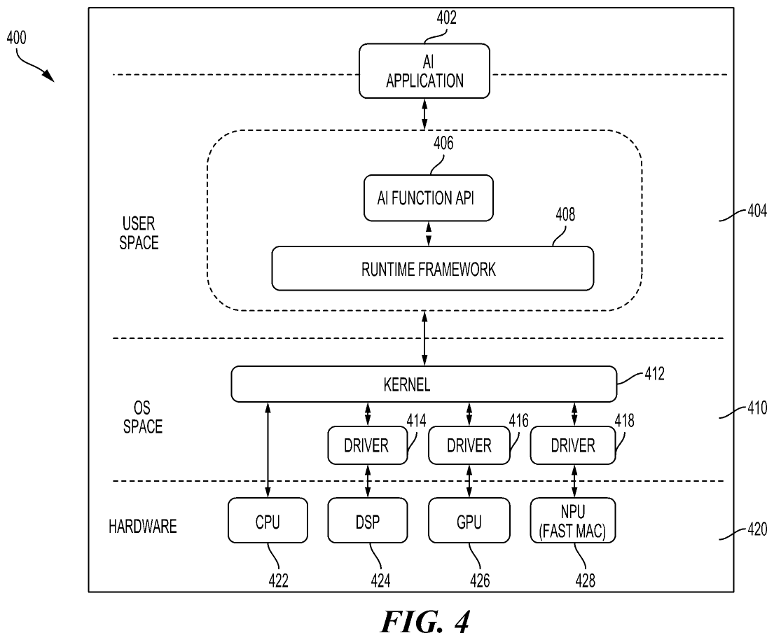

FIG. 4 is a block diagram illustrating an exemplary software architecture 400 that may modularize artificial intelligence (AI) functions. Using the architecture, applications may be designed that may cause various processing blocks of a system-on-a-chip (SoC) 420 (for example a CPU 422, a DSP 424, a GPU 426 and/or an NPU 428) to support dynamic class-incremental learning without forgetting for an AI application 402, according to aspects of the present disclosure.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine, for example, to request an inference at a particular time interval or triggered by an event detected by the user interface of the application. When caused to provide an inference response, the run-time engine may in turn send a signal to an operating system in an operating system (OS) space, such as a Kernel 412, running on the SoC 420. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The application 402 (e.g., an AI application) may be configured to call functions defined in a user space 404 that may, for example, provide for the detection and recognition of a scene indicative of the location in which the device currently operates. The application 402 may, for example, configure a microphone and a camera differently depending on whether the recognized scene is an office, a lecture hall, a restaurant, or an outdoor setting such as a lake. The application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine, for example, to request a scene estimate at a particular time interval or triggered by an event detected by the user interface of the application. When caused to estimate the scene, the run-time engine may in turn send a signal to an operating system 410, such as a Kernel 412, running on the SoC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as the driver 414-418 for the DSP 424, for the GPU 426, or for the NPU 428. In the exemplary example, the differential neural network may be configured to run on a combination of processing blocks, such as the CPU 422 and the GPU 426, or may be run on an NPU 428.

As described, aspects of the present disclosure are directed to dynamic class incremental learning without forgetting.

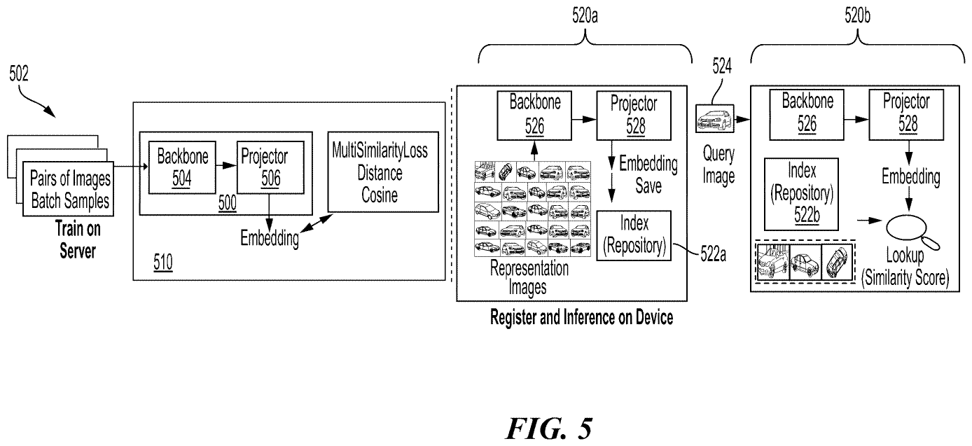

FIG. 5 is a block diagram illustrating an example architecture 500 for dynamic class incremental learning without forgetting, in accordance with aspects of the present disclosure. In accordance with aspects of the present disclosure, the example architecture may be an artificial neural network (ANN) model, for instance. The architecture 500 may be included on a server 510. The server 510 may be a remote computing device such as a cloud server, for example.

Referring to FIG. 5, the example architecture 500 may include a backbone 504 and a projector 506. The backbone 504 may include, for example, CNN models (e.g., 350 shown in FIG. 3) that may learn a representation for a downstream task. In some aspects, the backbone 504 may also take advantage of and include autoencoders, self-attention mechanisms, and transformers to effectively exploit a correlation between support sets so as to learn highly discriminative global features. As shown in FIG. 5, the example architecture 500 may receive an input 502. The input 502 may include an image, a video, sequence data, or other type of data. The input 502 may be supplied directly from one or more user devices or may be streamed via the Internet, for example. The input 502 may, for instance, include pairs of images or a batch of samples. The backbone 504 may process the input 502, extracting features of the input 502 to generate a representation of the input 502. The representation may be supplied to the projector 506.

The projector 506 may, for example, be a multilayer perceptron (MLP) model. The projector 506 may receive the representation from the backbone 504 and may project the representation to an embedding that may be contrasted with other representations, for instance using a multi-similarity loss.

The example architecture 500 may be self-supervised and trained using a multi-similarity loss on uncurated data sets of images, for example. The input 502 may be mined for pairs of samples (may also be referred to as “examples”) and weighted for pair-based loss functions. The example architecture 500 may learn to minimize the distance (e.g., cosine distance) between similar samples and to maximize the distance between dissimilar samples. A positive pair of samples with the lowest (or lower) similarity score and a negative pair with the highest (or higher) similarity score may be assigned the highest (or higher) weights. Accordingly, the example architecture 500 may train an artificial neural network (ANN) model on the server 510. The ANN model may, in turn, be distributed to one or more user devices 520a, 520b. The user device (e.g., 520a or 520b) may be a mobile electronic device (e.g., a smartphone, a wearable computing device (e.g., smartglasses)) or an autonomous driving vehicle, for example.

The user device (e.g., 520a or 520b) may train the ANN model on-device. Once the ANN model is trained on-device at the user device (e.g., 520a or 520b), an index (e.g., 522a or 522b) may be generated and may include the embeddings of the various items (e.g., classes in a training data set, without forgetting), for example. In some aspects, the index (e.g., 522a or 522b) may be searchable. For example, the user device 520b may observe a vehicle 524. The on-device ANN model may process the observation (e.g., an image of the vehicle 524 or a frame of a video including the vehicle 524). The on-device ANN model may operate in a manner similar to that described for the example architecture 500. That is, the on-device ANN model may extract features of the observation of the vehicle 524 using a backbone 526 to generate a representation of the observation of the vehicle 524. The representation may be supplied to a projector 528, which may project the representation to an embedding. The embedding of an item may comprise a mean-of-samples for the same classes (e.g., prototype features).

Additionally, the index (e.g., 522a or 522b) may be generated for new classes. The new classes may be dynamically added. Beneficially, the new classes may be added on-device without time consuming re-training the on-device ANN (e.g., backbone 526 or the projector 528). For example, the on-device ANN may generate an embedding (e.g., using the backbone 526 and projector 528) for representative samples of a new class. The embedding may then be saved and added to the index (e.g., 522a or 522b). Classifications may be made by a nearest-mean-of-samples rule. Accordingly, at inference (e.g., query) time, a fast approximate nearest neighbor search (e.g., using an ANN) may be leveraged to retrieve closest matching items from the index (e.g., 522a or 522b) in sub-linear time.

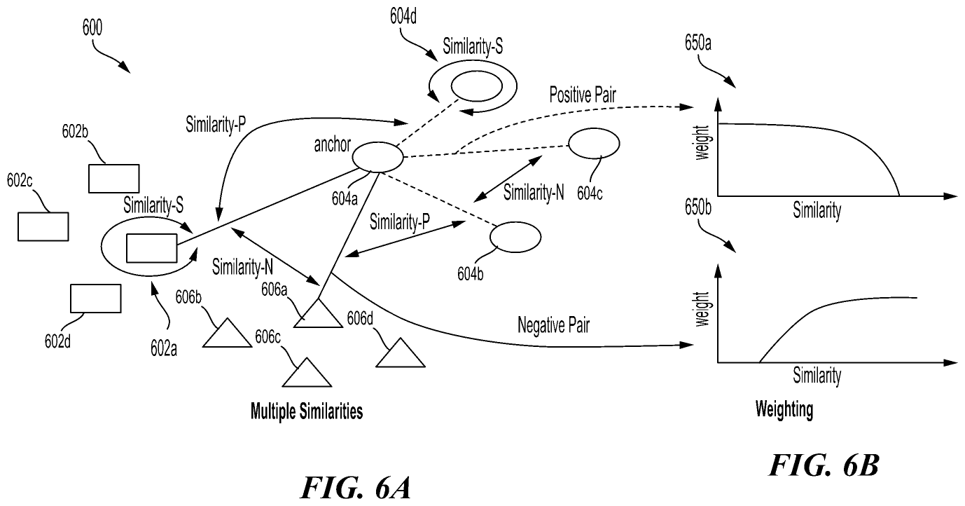

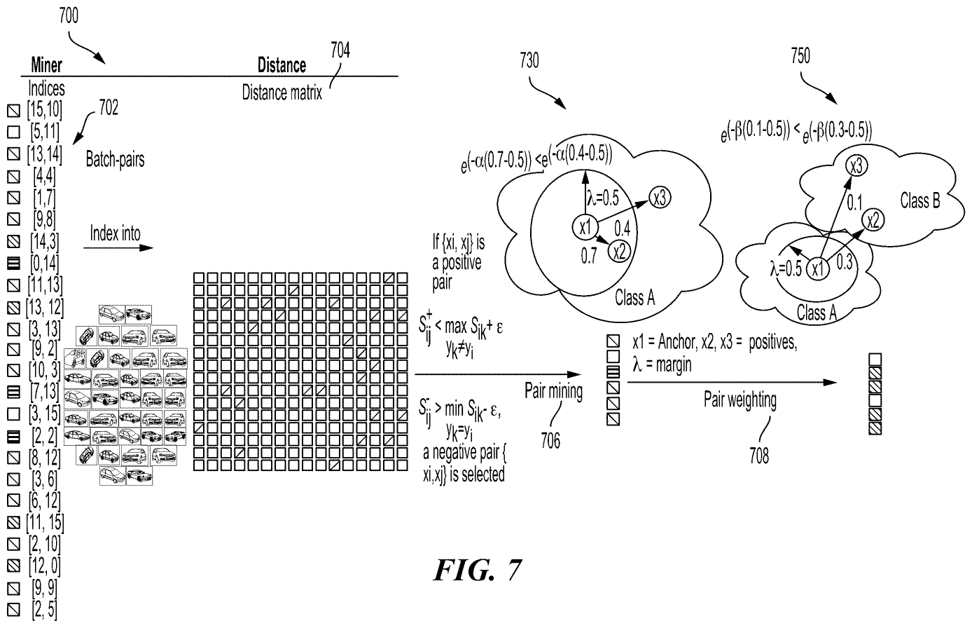

FIG. 6A is a diagram illustrating multi-similarity loss for an example dataset 600, in accordance with aspects of the present disclosure. Referring to FIG. 6A, the example dataset may include a set of data samples (e.g., 602a-d, 604a-d, 606a-d). The dataset 600 may, for example, be a training dataset. As described, the dataset 600 (e.g., a training dataset) may be mined for pairs of samples (may also be referred to as “examples”). Each of the shapes may represent a class for each of data samples. The rectangular shaped may represent positive sample pairs (e.g., 602a-d). The circle shapes may represent negative sample pairs (e.g., 604a-d). The triangle shapes may represent other sample pairs (e.g., 606a-d). Although four samples are shown each of the three classes, this is merely for ease of illustration and understanding and not limiting. Rather, any number of samples and classes may be included in the dataset

A data sample from the dataset 600 may be randomly selected as an anchor sample. For instance, as shown in the example of FIG. 6A, sample 604a is selected as the anchor. The anchor sample 604a may be used to evaluate the similarity of sample pairs in the dataset 600. Two other data samples in the dataset 600 may be selected and used to determine the multiple similarities. A data sample from the same class as the anchor sample may be referred to as a “positive” sample (e.g., 606d). Another data sample from a different class than the anchor sample 604a may be referred to as the “negative” sample (e.g., 602a).

In accordance with aspects of the present disclosure, the degree of similarity for the sample pairs may be determined based on multiple similarity metrics. The multiple similarity measures may include a similarity-S, a similarity-P, and a similarity-N, for example. However, this is merely an example, and not limiting. Rather, other measures of similarity may also be used. The similarity-P refers to a relative similarity measure compared with a positive pair. The similarity-N refers to a relative similarity measure compared with a negative pair.

The similarity-S may refer to a self-cosine similarity of a negative pair positive pair given anchor. Specifically, both of the negative pair with the large similarity-S and the positive pair with the small similarity-S may be regarded as hard pairs that may be more informative to learn embedding space as compared to more easily classified pairs. As shown in the example of FIG. 6A, the self-similarity may be computed using sample 604d and the anchor 604a as a positive pair and sample 602a and the anchor 604a as a negative pair.

In addition, relative similarity measures such as the similarity-P and similarity-N may be computed. Each of the similarity metrics may be calculated using the cosine similarity distance, for example. A similarity score may be determined based on the multiple similarity metrics (e.g., the similarity-S, the similarity-P, or the similarity-N). In turn, sample pairs may be weighted according to the degree of similarity, which may be indicated by the similarity score.

FIG. 6B shows example graphs 650a and 650b illustrating weighting of positive pairs and negative pairs, respectively, of FIG. 6A based on multiple similarities, in accordance with aspects of the present disclosure. As shown in the example graph 650a, positive pairs of samples with a lowest similarity score may be assigned the highest weights. As the similarity score increases for positive pairs, such positive pairs may be assigned lower weights in descending order, accordingly. On the other hand, as shown in the example graph 650b, negative pairs of samples with the lowest similarity score may be assigned the lowest weights. The weight may be increased in accordance with the similarity score with the negative pair having the highest similarity score being assigned the highest weights.

Using a multi-similarity loss function may enable the ANN model to learn directly from a random collection of images on the Internet, for example. Moreover, the ANN model may learn the random collection of images without the careful and time-consuming data curation and labeling used in conventional computer vision training. Then, the ANN may output an image embedding. Accordingly, aspects of the present disclosure may beneficially be applied to generate more powerful, fairer, and more robust computer vision models that may discover salient information in images by considering the relationships between the different objects observed. In some aspects, the ANN model (e.g., the on-device ANN model) may learn uncurated data sets of images via a greedy search or a grid search for hyperparameters.

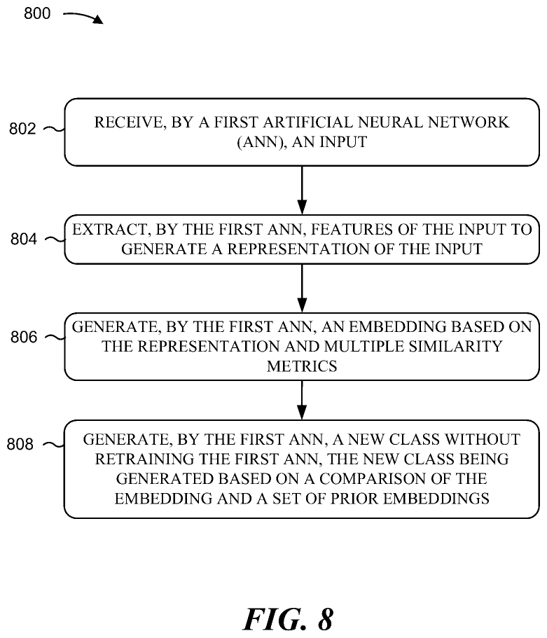

FIG. 7 is a visual flow diagram 700 illustrating an example process for computing a multi-similarity loss, in accordance with aspects of the present disclosure. Referring to FIG. 7, the flow diagram 700 may retrieve index information from indices (e.g., in 522a or 522b). Each of indices may represent a mean of samples of the same class (e.g., prototype of features). At 702, a miner may mine or search the index information for potential pairs. The potential pairs may be included in a distance matrix 704. and may be mined for pairs, at 706, of similar samples. As shown in FIG. 7, the multiple similarity may be determined according to a batch-pairs multi-similarity loss function. However, the present disclosure is not so limiting. Instead, other measures and techniques for determining multiple similarity may also be employed.

In the example of FIG. 7, a greedy search may be implemented to search for hyperparameters such as α,β,λ for computing the similarity score (e.g., pair weighing, at 708). The hyperparameter α may refer to the weight applied to positive pairs. The hyperparameter β may refer to the weight applied to negative pairs. The hyperparameter Δ may refer to an offset applied to an exponent in the batch-pairs multi-similarity loss function, which may be given by:

$${ℒ}_{M S} = \frac{1}{m} {\sum }_{i = 1}^{m} \{ \frac{1}{α} log [ 1 + {\sum }_{k ∈ {P}_{i}} {e}^{- α ( {S}_{i k} - λ )} ] + \frac{1}{β} log [ 1 + {\sum }_{k ∈ {N}_{i}} {e}^{β ( {S}_{i k} - λ )} ] \} \qquad ( 1 )$$

where m is a batch size (x₁, x₂, x₃, . . . , xₘ), i is an index of anchor sample (xᵢ), Pᵢ is a positive sample for a given anchor (xᵢ), Nᵢ is a negative sample for the given anchor (xᵢ), k is an item index in Pᵢ or Nᵢ and Sᵢₖ is a distance metric (e.g., Euclidean distance or cosine similarity) between the anchor (xᵢ) and its pair (xₖ).

Based on the similarity scores, the pairs may be weighted in a manner similar to that described relative to FIG. 6B, for example. For instance, as shown in FIG. 7, example data set 730 given an anchor x₁, a similarity of positive pairs may be determined. Sample x₂ and sample x₃ are in the same class (class A) and may each be paired with the anchor x₁ to form positive pairs (x₁, x₂) and (x₁, x₃), respectively. The similarity for the positive pairs may be determined. In the example of data set 730, given an offset λ of 0.5, the similarity for positive pair (x₁, x₂) may be e^{-α(0.7-0.5)} and the similarity for positive pair (x₁, x₃) may be e^{-α(0.4-0.5)}. The pairs may be weighted in the pair weighting step 708 based on the similarity. Because e^{-β(0.7-0.5)} is less than e^{-α(0.4-0.5)}, positive pair (x₁, x₂) may be assigned a greater weight than positive pair (x₁, x₃).

On the other hand, in example data set 750, given the offset λ of 0.5, the similarity of negative pairs may be determined. Sample x₂ and sample x₃ are in a different class (class B) than the anchor x₁ and may each be paired with the anchor x₁ to form negative pairs (x₁, x₂) and (x₁, x₃), respectively. In the example of data set 750, given an offset λ of 0.5, the similarity for negative pair (x₁, x₂) may be e^{-β(0.3-0.5)} and the similarity for negative pair (x₁, x₃) may be e^{-β(0.1-0.5)}. The pairs may be weighted in the pair weighting step 708 based on the similarity. Because e^{-β(0.3-0.5)} is greater than e^{-β(0.1-0.5)}, negative pair (x₁, x₂) may be assigned a greater weight than negative pair (x₁, x₃).

Accordingly, aspects of the present disclosure may beneficially combine embedding representation learning plus index and search for incremental learning without forgetting on-device. As such, aspects of the present disclosure may enable efficient resource usage by reducing, and in some aspects, eliminating retraining from scratch at the arrival of new data. In some aspects, memory usage may also be reduced by limiting the amount of data to be stored (e.g., when privacy limitations are imposed). Additional aspects may include learning that more closely resembles human learning and a one time “backbone and protector” on-device for low power optimization (e.g., quantization, etc.)

Further benefits may be achieved because, as described, the embeddings for representative items of new classes may be computed and added to an index. Accordingly, an unlimited new number of classes may be added to the index without having to retrain the on-device ANN model. This ability to dynamically add new classes is particularly useful when tackling problems where the number of distinct items is unknown ahead of time, constantly changing, or is extremely large.

Self-supervised training on diverse, real, and unfiltered internet data may also lead to interesting properties emerging, such as geo-localization, fairness, multilingual hashtag embeddings, as well as artistic information and improved semantic information. That is, in addition to capturing semantic information, aspects of the present disclosure may also capture information about artistic styles and learns salient information such as geolocations and multilingual word embeddings based on visual content only, for instance.

In some aspects, the on-device ANN model may be quickly finetuned for a specific task. For instance, if training a vision model on semantic segmentation for autonomous driving is desired, a camera may be installed in a car, and driving through a city for an hour may collect larger amounts data. In contrast, with conventional approaches using supervised learning, in which all the images would have to be manually labeled. Manual labeling is extremely expensive, and it is very time consuming (e.g., may take months) to manually label the same amount of data.

Furthermore, aspects of the present disclosure may learn a metric embedding space where the distance between embedded points is a function of a valid distance metric. These distance metrics may satisfy the triangle inequality, making the space amenable to an approximate nearest neighbor search and thus may lead to high retrieval accuracy. By applying the pair mining and pair weighting using the multi-similarity loss function many types of relative similarities among pairs may be determined. Additionally, pairs assigned the higher weights may be deemed more informative pairs and retained. On the other hand, pairs assigned lower weights may deemed less informative pairs and may be discarded. The weight of a given pair may depends on the self-similarity pairs as well as the relative comparison/similarity with other pairs in a training set.

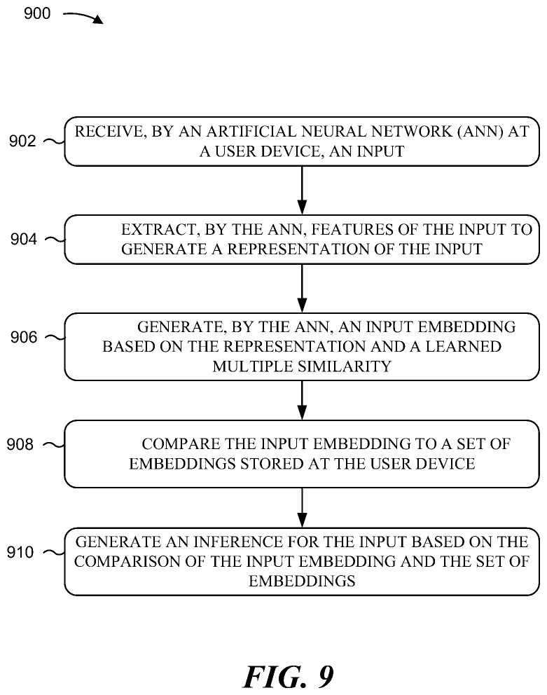

FIG. 8 is a flow diagram illustrating a processor-implemented method 800 for dynamic class-incremental learning without forgetting, in accordance with aspects of the present disclosure. The processor-implemented method 800 may be performed by a processor such as CPU 102 or NPU 108, for example. As shown in FIG. 8, at block 802, the processor receives, by a first artificial neural network (ANN), an input. The first ANN may be trained based on a multiple similarity loss function. In some aspects, the ANN may be included at a server, such as a cloud server, for instance. The input may comprise image data, video data, sensor data, sequence data, or other type of data. The input may be supplied directly from a user device or may be streamed via the Internet, for example.

At block 804, the processor extracts, by the first ANN, features of the input to generate a representation of the input. For example, as discussed with respect to FIG. 5, the backbone 504 may process the input 502, extracting features of the input 502 to generate a representation of the input 502.

At block 806, the processor generates, by the first ANN, an embedding based on the representation and multiple similarity metric. As described with reference to FIG. 5, the projector 506 may receive the representation from the backbone 504 and may project the representation to an embedding that may be contrasted with other representations, for instance using a multi-similarity loss.

At block 808, the processor generates by the first ANN, a new class without retraining the first ANN. The new class is generated based on a comparison of the embedding and a set of prior embeddings. As described with reference to FIG. 5, new classes may be dynamically added on-device without time consuming re-training. The ANN may generate an embedding (e.g., using the backbone 504 and projector 506) for representative samples of a new class.

FIG. 9 is a flow diagram illustrating a processor-implemented method 900 for dynamic class-incremental learning without forgetting, in accordance with aspects of the present disclosure. The processor-implemented method 900 may be performed by a processor such as CPU 102 or NPU 108, for example. The processor-implemented method 900 may be implemented by an artificial neural network (ANN) model. The ANN model may be included at a user device. The user device may comprise a mobile computing device such as a smartphone, an autonomous vehicle or other mobile computing device, for instance.

As shown in FIG. 9, at block 902, the processor receives, by an artificial neural network (ANN) at a user device, an input. The input may comprise image data, video data, sensor data, sequence data, or other type of data, for instance.

At block 904, the processor extracts, by the ANN, features of the input to generate a representation of the input. For example, as discussed with respect to FIG. 5, the on-device ANN model may extract features of the observation of the vehicle 524 using a backbone 526 to generate a representation of the observation of the vehicle 524.

At block 906, the processor generates, by the ANN, an input embedding based on the representation and a learned multiple similarity. As described with reference to FIG. 5, the representation may be supplied to a projector 528, which may project the representation to an embedding. In some aspects, the embedding of an item may comprise a mean-of-samples for the same classes (e.g., prototype features).

At block 908, the processor compares the input embedding to a set of embeddings stored at the user device. As described with reference to FIG. 5, the embedding may be saved and added to an index (e.g., 522a or 522b) at the user device.

At block 910, the processor generates an inference for the input based on the comparison of the input embedding and the set of embeddings. As described with reference to FIG. 5, classifications of inputs may be made by a nearest-mean-of-samples rule, for instance. At inference (e.g., query) time, a fast approximate nearest neighbor search (e.g., using an ANN) may be leveraged to retrieve closest matching items from the index (e.g., 522a or 522b) in sub-linear time.

Implementation examples are provided in the following numbered clauses:
1. A processor-implemented method, comprising:
   receiving, by a first artificial neural network (ANN), an input;
   extracting, by the first ANN, features of the input to generate a representation of the input;
   generating, by the first ANN, an embedding based on the representation and multiple similarity metrics; and
   generating, by the first ANN, a new class without retraining the first ANN, the new class being generated based on a comparison of the embedding and a set of prior embeddings.
2. The processor-implemented method of clause 1, in which the first ANN is trained based on a multiple similarity loss function.
3. The processor-implemented method of clause 1 or 2, in which the first ANN is implemented at a server and the method further comprises:
   training a second ANN, based on the multiple similarity loss function; and distributing, by the server, the second ANN model to a user device.
4. The processor-implemented method of any of clauses 1-3, further comprising determining a score for a pair of samples based on the multiple similarity metrics for the pair of samples included in the input, the embedding being generated based on the score.
5. The processor-implemented method of any of clauses 1-4, further comprising:
   mining the input and training samples to determine pairs of similar samples, the pairs of similar samples being determined based on a self-similarity and a relative similarity; and
   assigning a weight to the pairs of similar samples based on the self-similarity and the relative similarity.
6. A processor-implemented method, comprising:
   receiving, by an artificial neural network (ANN) at a user device, an input;
   extracting, by the ANN, features of the input to generate a representation of the input;
   generating, by the ANN, an input embedding based on the representation and a learned multiple similarity;
   comparing the input embedding to a set of embeddings stored at the user device; and
   generating an inference for the input based on the comparison of the input embedding and the set of embeddings.
7. The processor-implemented method of clause 6, further comprising:
   determining that the input comprises unseen data;
   generating an index for the embedding corresponding to the unseen data; and
   storing the embedding with the set of embeddings at the user device.
8. The processor-implemented method of clause 6 or 7, further comprising generating, by the ANN, a new class, the embedding corresponding to the unseen data being a prototype for the new class, and the new class being added without retraining the ANN.
9. An apparatus, comprising:
   a memory; and
   at least one processor coupled to the memory, the at least one processor configured:
      to receive, by a first artificial neural network (ANN), an input, the first ANN being trained based on a multiple similarity loss function;
      to extract, by the first ANN, features of the input to generate a representation of the input;
      to generate, by the first ANN, an embedding based on the representation and multiple similarity metrics; and
      to generate, by the first ANN, a new class without retraining the first ANN, the new class being generated based on a comparison of the embedding and a set of prior embeddings.
10. The apparatus of clause 9, in which the first ANN is trained based on a multiple similarity loss function.
11. The apparatus of clause 9 or 10, in which the first ANN is implemented at a server and the at least one processor is further configured:
   to train a second ANN, based on the multiple similarity loss function; and
   to distribute, by the server, the second ANN model to a user device.
12. The apparatus of any of clauses 9-11, in which the at least one processor is further configured to determine a score for a pair of samples based on the multiple similarity metrics for the pair of samples included in the input, the embedding being generated based on the score.
13. The apparatus of any of clauses 9-12, in which the at least one processor is further configured:
   to mine the input and training samples to determine pairs of similar samples, the pairs of similar samples being determined based on a self-similarity and a relative similarity; and
   to assign a weight to the pairs of similar samples based on the self-similarity and the relative similarity.
14. An apparatus, comprising:
   a memory; and
   at least one processor coupled to the memory, the at least one processor configured:
      to receive, by an artificial neural network (ANN) at a user device, an input;
      to extract, by the ANN, features of the input to generate a representation of the input;
      to generate, by the ANN, an input embedding based on the representation and a learned multiple similarity;
      to compare the input embedding to a set of embeddings stored at the user device; and
      to generate an inference for the input based on the comparison of the input embedding and the set of embeddings.
15. The apparatus of clause 14, in which the at least one processor is further configured:
   to determine that the input comprises unseen data;
   to generate an index for the embedding corresponding to the unseen data; and
   to store the embedding with the set of embeddings at the user device.
16. The apparatus of clause 14 or 15, in which the at least one processor is further configured to generate, by the ANN, a new class, the embedding corresponding to the unseen data being a prototype for the new class, and the new class being added without retraining the ANN.

In one aspect, the receiving means, the extracting, comparing and/or the generating means may be the CPU 102, program memory associated with the CPU 102, the dedicated memory block 118, fully connected layers 362, NPU 428, and/or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, e, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs. and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method, comprising:
receiving, by a first artificial neural network (ANN), an input;
extracting, by the first ANN, features of the input to generate a representation of the input;
generating, by the first ANN, an embedding based on the representation and multiple similarity metrics; and
generating, by the first ANN, a new class without retraining the first ANN, the new class being generated based on a comparison of the embedding and a set of prior embeddings.

2. The processor-implemented method of claim 1, in which the first ANN is trained based on a multiple similarity loss function.

3. The processor-implemented method of claim 2, in which the first ANN is implemented at a server and the method further comprises:
training a second ANN, based on the multiple similarity loss function; and
distributing, by the server, the second ANN model to a user device.

4. The processor-implemented method of claim 1, further comprising determining a score for a pair of samples based on the multiple similarity metrics for the pair of samples included in the input, the embedding being generated based on the score.

5. The processor-implemented method of claim 1, further comprising:
mining the input and training samples to determine pairs of similar samples, the pairs of similar samples being determined based on a self-similarity and a relative similarity; and
assigning a weight to the pairs of similar samples based on the self-similarity and the relative similarity.

6. A processor-implemented method, comprising:
receiving, by an artificial neural network (ANN) at a user device, an input;
extracting, by the ANN, features of the input to generate a representation of the input;
generating, by the ANN, an input embedding based on the representation and a learned multiple similarity;
comparing the input embedding to a set of embeddings stored at the user device; and
generating an inference for the input based on the comparison of the input embedding and the set of embeddings.

7. The processor-implemented method of claim 6, further comprising:
determining that the input comprises unseen data;
generating an index for the embedding corresponding to the unseen data; and
storing the embedding with the set of embeddings at the user device.

8. The processor-implemented method of claim 7, further comprising generating, by the ANN, a new class, the embedding corresponding to the unseen data being a prototype for the new class, and the new class being added without retraining the ANN.

9. An apparatus, comprising:
a memory; and
at least one processor coupled to the memory, the at least one processor configured:
to receive, by a first artificial neural network (ANN), an input, the first ANN being trained based on a multiple similarity loss function;
to extract, by the first ANN, features of the input to generate a representation of the input;
to generate, by the first ANN, an embedding based on the representation and multiple similarity metrics; and
to generate, by the first ANN, a new class without retraining the first ANN, the new class being generated based on a comparison of the embedding and a set of prior embeddings.

10. The apparatus of claim 9, in which the first ANN is trained based on a multiple similarity loss function.

11. The apparatus of claim 10, in which the first ANN is implemented at a server and the at least one processor is further configured:
to train a second ANN, based on the multiple similarity loss function; and
to distribute, by the server, the second ANN model to a user device.

12. The apparatus of claim 9, in which the at least one processor is further configured to determine a score for a pair of samples based on the multiple similarity metrics for the pair of samples included in the input, the embedding being generated based on the score.

13. The apparatus of claim 9, in which the at least one processor is further configured:
to mine the input and training samples to determine pairs of similar samples, the pairs of similar samples being determined based on a self-similarity and a relative similarity; and
to assign a weight to the pairs of similar samples based on the self-similarity and the relative similarity.

14. An apparatus, comprising:
a memory; and
at least one processor coupled to the memory, the at least one processor configured:
to receive, by an artificial neural network (ANN) at a user device, an input;
to extract, by the ANN, features of the input to generate a representation of the input;
to generate, by the ANN, an input embedding based on the representation and a learned multiple similarity;
to compare the input embedding to a set of embeddings stored at the user device; and
to generate an inference for the input based on the comparison of the input embedding and the set of embeddings.

15. The apparatus of claim 14, in which the at least one processor is further configured:
to determine that the input comprises unseen data;
to generate an index for the embedding corresponding to the unseen data; and
to store the embedding with the set of embeddings at the user device.

16. The apparatus of claim 15, in which the at least one processor is further configured to generate, by the ANN, a new class, the embedding corresponding to the unseen data being a prototype for the new class, and the new class being added without retraining the ANN.
